(19) United States
(12) Patent Application Publication
(10) Pub. No.: US 2026/0169955 A1
(43) Pub. Date: Jun. 18, 2026

(54) IMAGE READING APPARATUS THAT SETS SELECTED FOLDER AS SAVING DESTINATION OF IMAGE DATA, WHEN PREDETERMINED CONDITION IS SATISFIED

(71) Applicant: KYOCERA Document Solutions Inc., Osaka (JP)

(72) Inventors: Louella VILLAMORA, Osaka (JP); Dannovan Paul DEVIS, Osaka (JP); Rogelio MAHUSAY, JR., Osaka (JP)

(73) Assignee: KYOCERA Document Solutions Inc., Osaka (JP)

(21) Appl. No.: 19/397,997

(22) Filed: Nov. 23, 2025

(30) Foreign Application Priority Data
Nov. 27, 2024 (JP) 2024-206771

(51) Int. Cl. G06F 16/11; G06F 21/62

(52) U.S. Cl. CPC G06F 16/122; G06F 21/6218

(57) ABSTRACT

An image reading apparatus includes an image reading device, an operation device, and a controller. The image reading device reads a document, and generates image data. To the operation device, an instruction of a user is inputted. The controller executes a process including setting, when a selection instruction for selecting one of a plurality of folders, use of which is restricted, as saving destination, is received through the operation device, and a predetermined condition for cancelling the use restriction of the folder as the saving destination is satisfied, the folder indicated by the selection instruction as the saving destination of the image data, and saving the image data in the set saving destination.

### INCORPORATION BY REFERENCE

This application claims priority to Japanese Patent Application No. 2024-206771 filed on Nov. 27, 2024, the entire contents of which are incorporated by reference herein.

### BACKGROUND

The present disclosure relates to an image reading apparatus, and in particular to a technique to set a saving destination of image data.

Various techniques are known that include executing a predetermined process with respect to image data acquired, on an image reading apparatus that reads a document and generates image data.

For example, a first technique is known that includes detecting a two-dimensional code from the image data acquired through reading a paper document, and generating a document file by embedding character data indicating related information contained in the detected two-dimensional code, in the image data.

A second known technique includes displaying a screen for making a user select a desired code, on a display device, when a plurality of codes are detected from a scanned image, and executing a process utilizing the selected code.

Further, a third known technique includes detecting the two-dimensional code from the image data acquired through reading a plurality of documents, and sorting the plurality of documents according to a sorting method contained in the detected two-dimensional code.

### SUMMARY

The disclosure proposes further improvement of the foregoing techniques.

In an aspect, the disclosure provides an image reading apparatus including an image reading device, an operation device, and a controller. The image reading device reads a document, and generates image data. To the operation device, an instruction of a user is inputted. The controller includes a processor, and executes, when the processor executes a control program, a process including setting, when a selection instruction for selecting one of a plurality of folders, use of which is restricted, as saving destination, is received through the operation device, and a predetermined condition for cancelling use restriction of the folder as the saving destination is satisfied, the folder indicated by the selection instruction as the saving destination of the image data, and saving the image data in the set saving destination.

### BRIEF DESCRIPTION OF THE DRAWINGS

FIG. 1 is a front cross-sectional view showing a structure of an image forming apparatus;

FIG. 2 is a block diagram showing an internal configuration of the image forming apparatus;

FIG. 3 is a schematic drawing showing an example of an address book;

FIG. 4 is a schematic drawing showing an example of a log-in screen;

FIG. 5 is a schematic drawing showing an example of a home screen;

FIG. 6 is a schematic drawing showing an example of a job selection screen;

FIG. 7 is a flowchart showing a first transmission destination setting process;

FIG. 8 is a schematic drawing showing an example of a transmission destination selection screen;

FIG. 9 is a schematic drawing showing an example of a password input screen;

FIG. 10 is a schematic drawing showing an example of a transmission destination setting screen;

FIG. 11 is a flowchart showing a second transmission destination setting process;

FIG. 12 is a flowchart showing a third transmission destination setting process; and

FIG. 13 is a schematic drawing showing another example of the transmission destination selection screen.

### DETAILED DESCRIPTION

Hereafter, an image forming apparatus, including an image reading apparatus according to an embodiment of the disclosure, will be described, with reference to the drawings.

### Configuration of Image Forming Apparatus 1

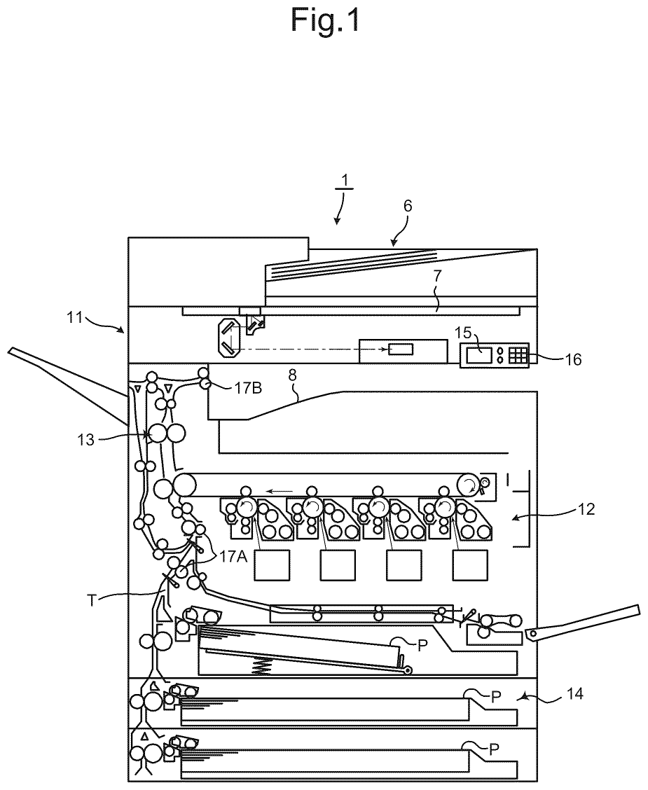

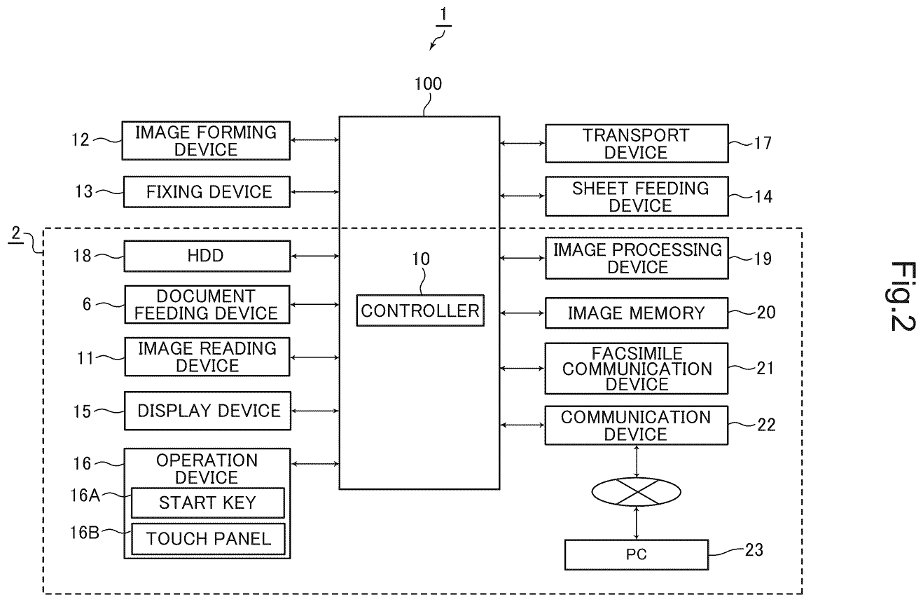

FIG. 1 is a front cross-sectional view showing a structure of the image forming apparatus 1. FIG. 2 is a block diagram showing an internal configuration of the image forming apparatus 1. Referring to FIG. 1 and FIG. 2, the image forming apparatus 1 is a multifunction peripheral having a plurality of functions, such as copying, transmitting, printing, and facsimile transmission.

The image forming apparatus 1 includes a document feeding device 6, an image reading device 11, an image forming device 12, a fixing device 13, a sheet feeding device 14, a display device 15, an operation device 16, and a transport device 17.

The document feeding device 6 delivers documents placed on a document tray one by one to a reading position of the image reading device 11. The document feeding device 6 is configured to open and close a platen glass 7, by being made to pivot up and downward about a shaft located on the deeper side in FIG. 1. The document feeding device 6 also serves as a document retention cover that presses the document on the platen glass 7 from the upper side.

The image reading device 11 includes a scanner that optically reads the document, and generates the image data representing the document image. The image reading device 11 reads the document delivered from the document feeding device 6, or the document placed on the platen glass 7.

The image forming device 12 includes a photoconductor drum, a charging device, an exposure device, a developing device, and a primary transfer device. The image forming device 12 forms a toner image on a sheet P transported along a transport route T by the transport device 17, on the basis of the image data generated by the image reading device 11, or image data inputted through the communication device 22.

The fixing device 13 heats and presses the sheet P on which the toner image has been formed, to thereby fix the toner image onto the sheet P. The sheet P on which the image has been formed by fixing the toner image is delivered to an output tray 8.

The sheet feeding device 14 includes a manual bypass tray and a plurality of sheet cassettes. The sheet feeding device 14 draws out the sheets P stored in one of the plurality of sheet cassettes, or set on the manual bypass tray one by one with a pickup roller, and delivers the sheet P to the transport route T. Here, the sheet P is not limited to a paper medium but may be, for example, an overhead projector (OHP) sheet.

The display device 15 includes a liquid crystal display or an organic light-emitting diode display, and displays various types of screen.

The operation device 16 includes a plurality of hard keys such as a start key 16A, for inputting instructions to execute a copying operation or a scanning operation. The operation device 16 also includes a touch panel 16B overlaid on the display device 15. To the operation device 16, the instruction from the user is inputted.

The transport device 17 includes transport roller pairs 17A, a delivery roller pair 17B, and a transport motor. When the transport roller pair 17A and the delivery roller pair 17B are driven to rotate by the transport motor, the sheet P delivered from the sheet feeding device 14 is transported along the transport route T.

Referring to FIG. 2, the image forming apparatus 1 further includes a control device 100, a hard disk drive (HDD) 18, an image processing device 19, an image memory 20, a facsimile communication device 21, and a communication device 22.

The control device 100 includes a processor, a random-access memory (RAM), and a read-only memory (ROM). The processor is, for example, a central processing unit (CPU), a micro processing unit (MPU), or an application specific integrated circuit (ASIC).

The control device 100 acts as a controller 10, when the processor executes a control program stored in the ROM or the HDD 18. The controller 10 controls the operation of the components of the image forming apparatus 1. Here, the controller 10 may be constituted in the form of a logic circuit, instead of being realized by the operation based on the control program.

The control device 100 is electrically connected to the document feeding device 6, the image reading device 11, the image forming device 12, the fixing device 13, the sheet feeding device 14, the display device 15, the operation device 16, the transport device 17, the HDD 18, the image processing device 19, the image memory 20, the facsimile communication device 21, and the communication device 22.

In this embodiment, the control device 100, the document feeding device 6, the image reading device 11, the display device 15, the operation device 16, the HDD 18, the image processing device 19, the image memory 20, the facsimile communication device 21, and the communication device 22 act as an image reading apparatus 2.

The HDD 18 is a large-capacity storage medium for storing various types of data. In the HDD 18, various control programs for realizing the functions of the image forming apparatus 1 are stored. The HDD 18 contains, as an example of the various control programs, a first setting program for executing a first transmission destination setting process, to be subsequently described.

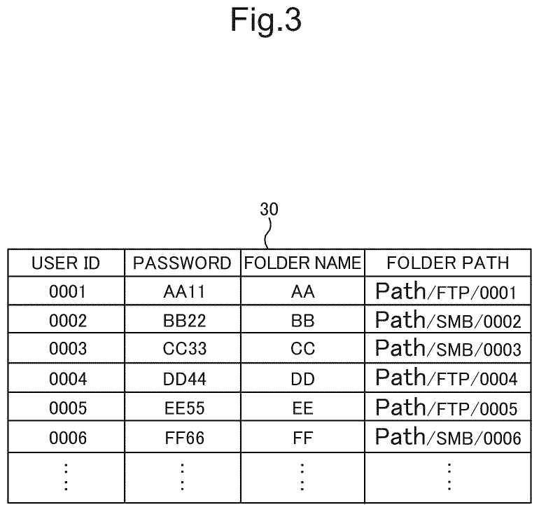

In the HDD 18, a password is stored with respect to each of the folders, and folder information and user information are also stored, in association with each other. To be more specific, the HDD 18 contains in advance an address book 30 shown in FIG. 3, indicating the user ID and the password constituting the user information, and the name and the path of the folder, constituting the folder information, in association with each other. The HDD 18 exemplifies the storage device in the disclosure.

Here, although the password for the folder and the password in the user information are commonly specified in the address book 30, the disclosure is not limited to such an embodiment. For example, the password for the folder may be differently specified from the password in the user information.

In addition, although one piece of folder information is associated with one piece of user information, in the address book 30, the disclosure is not limited to such an embodiment. For example, a plurality of pieces of folder information may be associated with one piece of user information.

The image processing device 19 executes image processing, as necessary, with respect to the image data generated by the image reading device 11. In the image memory 20, the image data generated by the image reading device 11 is temporarily stored. The facsimile communication device 21 transmits and receives the image data, through the public telephone network.

The communication device 22 includes a communication module such as a local area network (LAN) board. The controller 10 performs data communication through the communication device 22, with an external device such as a personal computer (PC) 23 connected via a network.

A power source is connected to each of the components of the image forming apparatus 1. When the user turns the power on, the power is supplied from the power source, to each of the components of the image forming apparatus 1.

### Operation

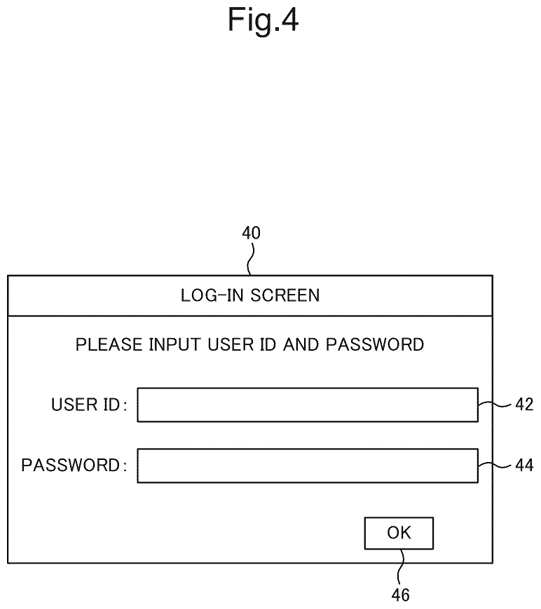

Referring to FIG. 4 to FIG. 10, an operation of the image forming apparatus 1, performed when executing the first transmission destination setting process according to the first embodiment, will be described hereunder.

When the power to the image forming apparatus 1 is turned on, the controller 10 causes the display device 15 to display a log-in screen 40 shown in FIG. 4. When the touch panel 16B detects, for example, an input made by the user through the software keyboard, the controller 10 causes the display device 15 to display the inputted character string in boxes 42 and 44.

It will be assumed here that a character string “0001” is displayed in the box 42 indicating the user ID, and a character string “AA11” is displayed in the box 44 indicating the password, on the display device 15.

When the touch panel 16B detects a touch operation of the user on the key 45, under such a situation, the controller 10 receives the instruction to execute authentication for logging-in, and decides whether the inputted information (combination of the character strings inputted to the boxes 42 and 44) accords with one piece of the information (combination of the user ID and the password) registered in the address book 30.

Upon deciding that the inputted information accords with one piece of user information registered in the address book 30, the controller 10 permits the logging-in of the user. However, in the case of deciding that the inputted information accords with none of the user information registered in the address book 30, the controller 10 does not permit the logging-in of the user.

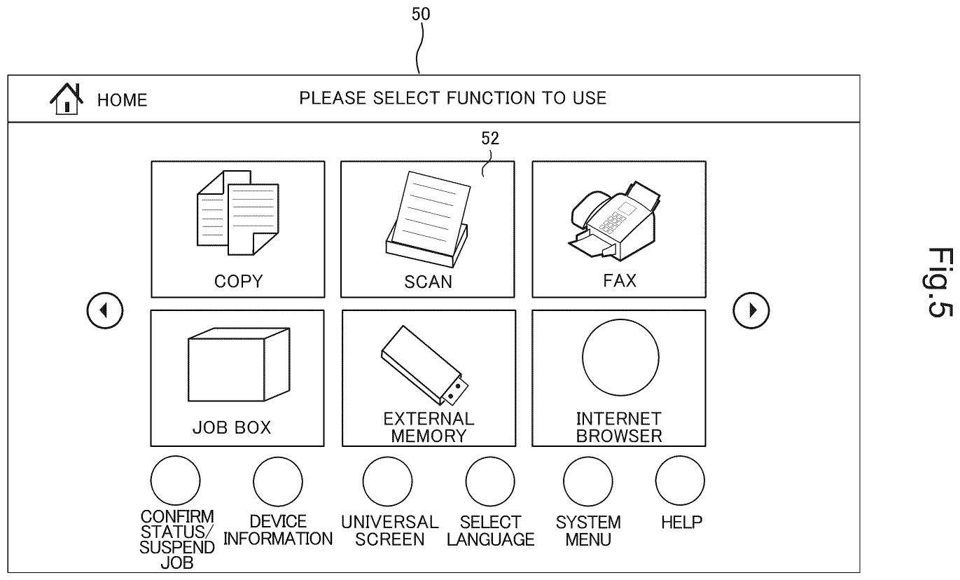

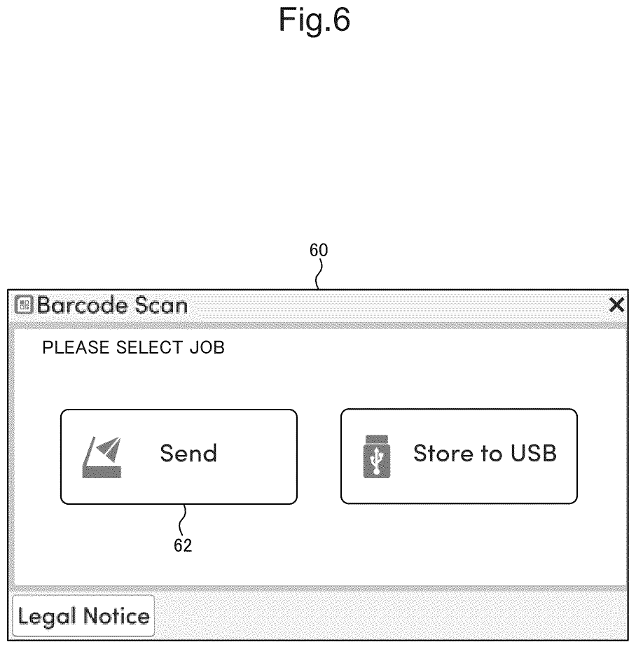

After permitting the logging-in of the user, the controller 10 causes the display device 15 to display a home screen 50 shown in FIG. 5. When the touch panel 16B detects the touch operation of the user on a key 52 in the home screen 50, the controller 10 receives the instruction to select the scanning function, and causes the display device 15 to display a job selection screen 60 shown in FIG. 6.

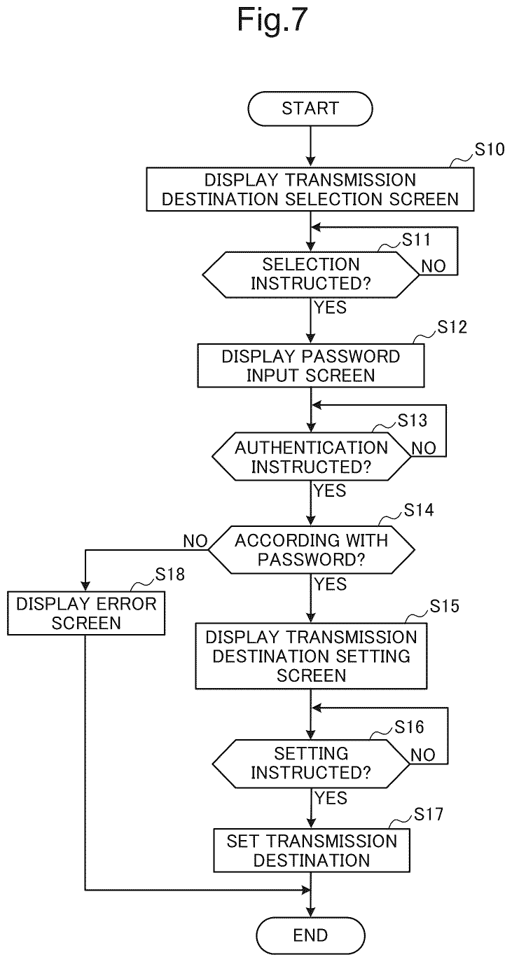

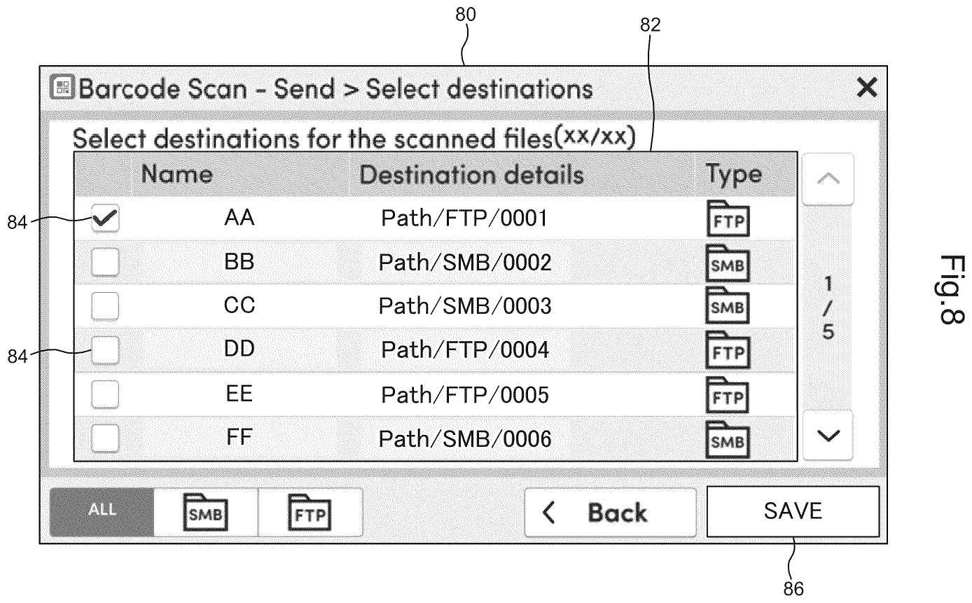

When the touch panel 16B detects the touch operation of the user on a key 62 in the job selection screen 60, the controller 10 receives the instruction to select the transmission job, and starts to execute a first transmission destination setting process, specified in FIG. 7. In the first transmission destination setting process, first the controller 10 causes the display device 15 to display a transmission destination selection screen 80 shown in FIG. 8 (step S10).

At this time, the controller 10 causes the display device 15 to display a list 82 indicating the name and the path of the folders registered in the address book 30, on the transmission destination selection screen 80. After step S10, the controller 10 repeatedly decides that the instruction to select one of a plurality of folders, the use of which is restricted, as the saving destination, has not been received, until a key 86 in the transmission destination selection screen 80 is touched (NO at step S11).

When the touch panel 16B detects the touch operation of the user on one of a plurality of checkboxes 84 respectively corresponding to a plurality of folders, the controller 10 causes the display device 15 to display a check mark in the touched checkbox 84. Here, it will be assumed that the controller 10 causes the display device 15 to display the check mark in a checkbox 84, corresponding to the folder having the name “AA” and the path “Path/FTP/0001”.

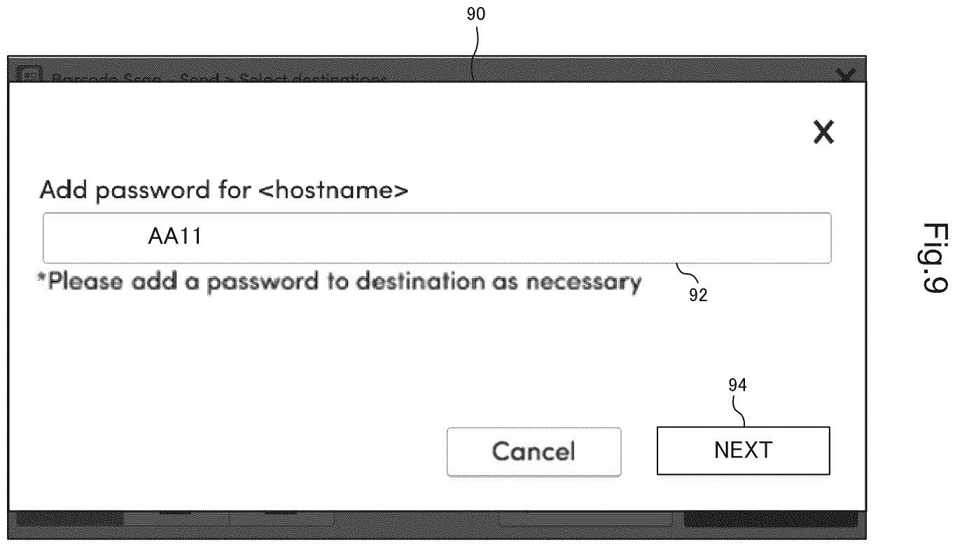

When the touch panel 16B detects the touch operation of the user on the key 86, with the check mark being displayed in one of the plurality of checkboxes 84, the controller 10 decides that the instruction to select the folder has been received (YES at step S11), and causes the display device 15 to display a password input screen 90 shown in FIG. 9 (step S12).

After step S12, the controller 10 repeatedly decides that an instruction for authentication of the password has not been received, until a key 94 in the password input screen 90 is touched (NO at step S13). When the touch panel 16B detects, for example, an input made by the user through the software keyboard, the controller 10 causes the display device 15 to display the inputted character string (in this case, “AA11”), in the box 92.

When the touch panel 16B detects a touch operation of the user on the key 94, under such a situation, the controller 10 decides that the instruction for authentication of the password has been received, (YES at step S13). Then the controller 10 acquires the password corresponding to the folder indicated by the selection instruction (in this case, “AA11”) from the address book 30, and decides whether the acquired password accords with the inputted character string (step S14).

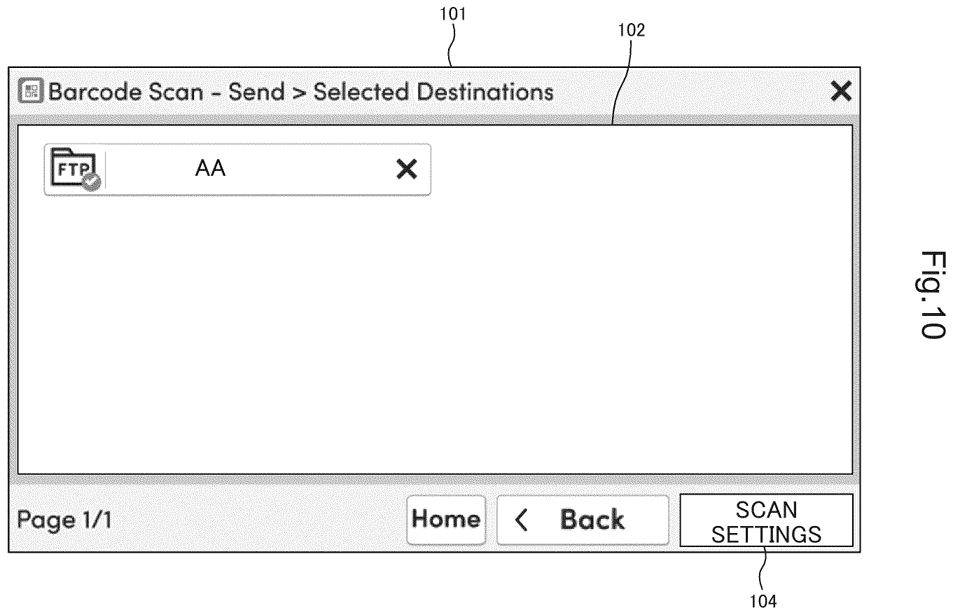

In this case, the controller 10 decides that the acquired password accords with the inputted character string (YES at step S14), and causes the display device 15 to display a transmission destination setting screen 101 shown in FIG. 10 (step S15). At this time, the controller 10 causes the display device 15 to display a list 102, indicating the folder selected from the transmission destination selection screen 80, on a transmission destination setting screen 101.

After step S15, the controller 10 repeatedly decides that an instruction to set the transmission destination has not been received, until a key 104 in the transmission destination setting screen 101 is touched (NO at step S16). When the touch panel 16B detects the touch operation of the user on the key 104, under such a situation, the controller 10 decides that the setting instruction has been received (YES at step S16), and designates the folder indicated by the list 102 as the transmission destination of the image file (step S17). After step S17, the controller 10 finishes the first transmission destination setting process.

In contrast, upon deciding decides that the acquired password and the inputted character string discord from each other (NO at step S14), the controller 10 causes the display device 15 to display an error screen indicating that the password is wrong, without setting the folder indicated by the selection instruction as the transmission destination of the image file (step S18). After step S18, the controller 10 finishes the first transmission destination setting process.

Upon setting the transmission destination of the image file as described above, the controller 10 causes the image reading device 11 to read a plurality of documents sequentially delivered from the document feeding device 6 one by one, or the document placed on the platen glass 7, and generate the image data representing the document image.

The controller 10 then converts the generated image data into the image file of a predetermined file format (e.g., portable document format (PDF)). The controller 10 transmits, via the communication device 22, the generated image file to the folder indicated by the transmission destination set as above, using a server message block (SMB) transmission function or a file transfer protocol (FTP) transmission function, to save the image file in that folder.

In the aforementioned known image reading apparatuses, the address book for selecting the saving destination of the image data may be registered in advance. Upon receipt of an instruction to select one of a plurality of folders included in the address book, for example via the touch panel, the image reading apparatus transmits the generated image data to the folder indicated by the selection instruction, and store the image data therein.

In the case of the image reading apparatus configured as above, however, the user can select any of the plurality of folders included in the address book, and therefore there is a risk that the user may transmit highly confidential image data, representing a classified document, to a folder of a third party by mistake, instead of the user's own folder.

In contrast, according to the first embodiment, when the instruction to select one of the plurality of folders the use of which is restricted, as the saving destination, is received via the operation device 16, and a predetermined condition for cancelling the use restriction of the folder as the saving destination is satisfied, the controller 10 designates the folder indicated by the selection instruction as the saving destination of the image file, and saves the image file in the designated saving destination.

Thus, the image file is stored in the folder selected by the user, only when the predetermined condition for cancelling the use restriction of the folder as the saving destination is satisfied. Such an arrangement prevents confidential image data from being transmitted by mistake to the folder of a third party, thereby upgrading the security level related to the setting of the transmission destination.

According to the first embodiment, the controller 10 causes the display device 15 to display the password input screen 90, upon receipt of the selection instruction of the folder, and acquires, when a character string is inputted via the operation device 16, the password corresponding to the folder indicated by the selection instruction, from the HDD 18. Then the controller 10 designates the folder indicated by the selection instruction as the saving destination of the image file, when the acquired password accords with the inputted character string, but keeps from designating the folder indicated by the selection instruction as the saving destination of the image file, when the acquired password discords from the inputted character string.

Thus, the use of the plurality of folders is restricted by the password, and the image file can be saved in the folder, only when the password determined in advance in association with the selected folder is inputted. Accordingly, the user is unable to save the image file in the folders other than the one that the user is authorized to use. Such an arrangement surely prevents the confidential image data from being transmitted to the folder of a third party by mistake, thereby further upgrading the security level related to the setting of the transmission destination.

### Second Embodiment

Hereunder, a second embodiment of the disclosure will be described. The description of the same configurations and the same operations as those of the first embodiment will not be repeated.

### Configuration of Image Forming Apparatus 1

In the image forming apparatus 1 according to the second embodiment of the disclosure, the HDD 18 contains, in place of the first setting program, a second setting program for executing a second transmission destination setting process, to be subsequently described.

### Operation

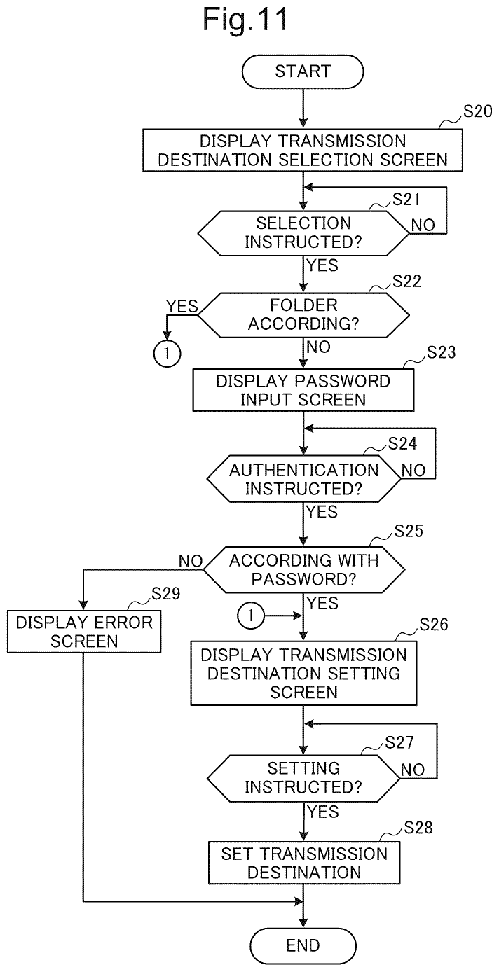

Referring to FIG. 11, an operation of the image forming apparatus 1, performed when executing the second transmission destination setting process, will be described hereunder.

The operation of steps S20, S21, and S23 to S29 in the second transmission destination setting process shown in FIG. 11 is the same as that of the steps S10 to S18 in the first transmission destination setting process shown in FIG. 7. Accordingly, the operation of step S22 of the second transmission destination setting process will be described hereunder.

In the second transmission destination setting process, the controller 10 decides, upon deciding that the selection instruction of the folder has been received (YES at step S21), whether the folder indicated by the folder information corresponding to the user information of the log-in user, registered in the address book 30, and the folder indicated by the selection instruction accord with each other (step S22).

Upon deciding that the folder indicated by the folder information and the folder indicated by the selection instruction discord from each other (NO at step S22), the controller 10 executes the operation of step S23 and the subsequent steps. Upon deciding that the folder indicated by the folder information and the folder indicated by the selection instruction accord with each other (YES at step S22), the controller 10 executes the operation of step S26 and the subsequent steps, without executing the operation of steps S23 to S25.

According to the second embodiment, (i) in the case where the information inputted via the operation device 16 and the user information accord with each other (i.e., when logging-in is permitted), the controller 10 causes the display device 15 to display the password input screen 90, when the folder indicated by the folder information corresponding to the user information of the log-in user, and the folder indicated by the selection instruction discord from each other, but designates the folder indicated by the selection instruction as the saving destination of the image file, without causing the display device 15 to display the password input screen 90, when the folder indicated by the folder information and the folder indicated by the selection instruction accord with each other. (ii) In the case where the information inputted via the operation device 16 and the user information discord from each other (i.e., when logging-in is not permitted), the controller 10 does not designate the saving destination of the image file.

Accordingly, the log-in user can save the image file in his/her own folder, associated in advance with his/her own user information, without the need to input the password. Therefore, the convenience to the user can be improved.

### Third Embodiment

Hereunder, a third embodiment of the disclosure will be described. The description of the same configurations and the same operations as those of the first embodiment will not be repeated.

### Configuration of Image Forming Apparatus 1

In the image forming apparatus 1 according to the third embodiment of the disclosure, the HDD 18 contains, in place of the first setting program, a third setting program for executing a third transmission destination setting process, to be subsequently described.

### Operation

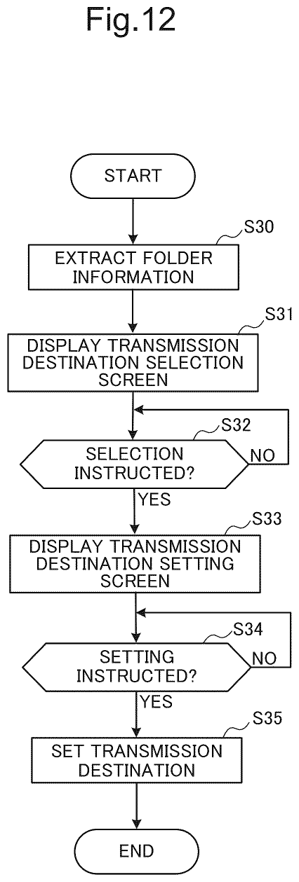

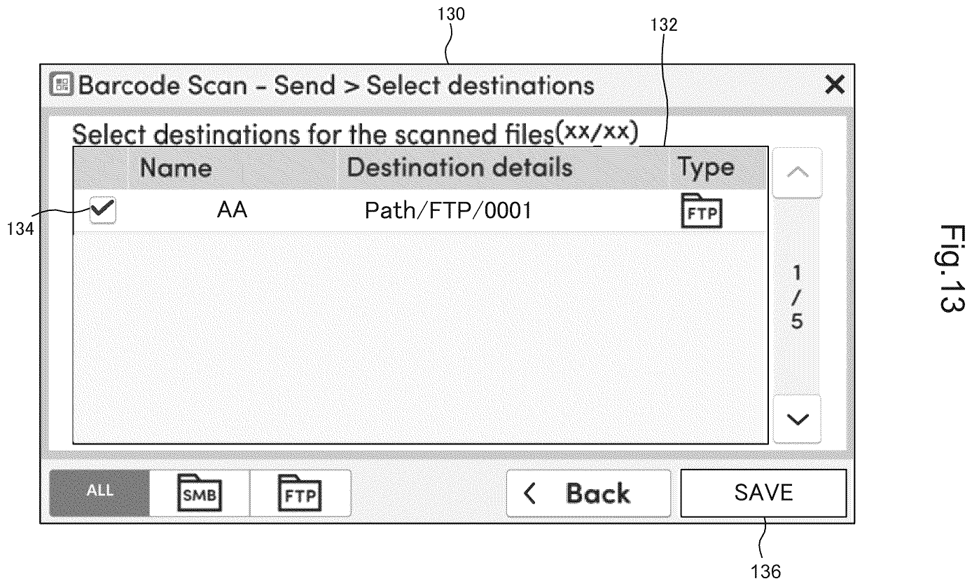

Referring to FIG. 12 and FIG. 13, an operation of the image forming apparatus 1, performed when executing the third transmission destination setting process, will be described hereunder.

The operation of steps S33 to S35 in the third transmission destination setting process shown in FIG. 12 is the same as that of the steps S15 to S17 in the first transmission destination setting process shown in FIG. 7. Accordingly, the operation of steps S30 to S32 of the third transmission destination setting process will be described hereunder.

In the third transmission destination setting process, first the controller 10 extracts the folder information (folder name and path) corresponding to the user information of the log-in user, from the address book 30 (step S30). After step S30, the controller 10 causes the display device 15 to display a transmission destination selection screen 130 shown in FIG. 13 (step S31).

At this time, the controller 10 causes the display device 15 to display a list 132, showing the folder information extracted from the address book 30, in the transmission destination selection screen 130. Thus, the controller 10 enables the folder indicated by the folder information corresponding to the user information of the log-in user, among a plurality of folders, to be selected as the saving destination of the image file, and disables the remaining folders from being selected as the saving destination of the image file.

After step S31, the controller 10 repeatedly decides that the instruction to select the folder has not been received, until a key 136 in the transmission destination selection screen 130 is touched (NO at step S32). When the touch panel 16B detects the touch operation of the user on a checkboxes 134, corresponding to the extracted folder (in this case, one folder), under such a situation, the controller 10 causes the display device 15 to display a check mark in the touched checkbox 134.

When the touch panel 16B detects the touch operation of the user on the key 136, with the check mark being displayed in the checkbox 134, corresponding to the extracted folder, the controller 10 decides that the instruction to select the folder has been received (YES at step S32), and executes the operation of step S33 and the subsequent steps.

According to the third embodiment, when the information inputted via the operation device 16 and the user information accord with each other (i.e., when logging-in is permitted), the controller 10 enables the folder indicated by the folder information corresponding to the user information of the log-in user to be selected as the saving destination of the image file, among the plurality of folders, and disables the remaining folders from being selected as the saving destination of the image file. When the information inputted via the operation device 16 and the user information discord from each other (i.e., when logging-in is not permitted), the controller 10 does not designate the saving destination of the image file.

Thus, the use of the plurality of folders by non-log-in users is restricted, and the log-in user can save the image file only in his/her own folder, associated in advance with his/her own user information. In other words, the log-in user is restricted from saving the image file in the folders other than his/her own folder. Therefore, for example, a highly confidential image file can be prevented from being transmitted by mistake to a folder of a third party, which leads to further improvement in security level related to the setting of the transmission destination.

The disclosure may be modified in various manners, without limitation to the foregoing embodiments. For example, although the image forming apparatus 1 is exemplified by the color multifunction peripheral in the embodiments, the disclosure is also applicable to other types of image forming apparatus, such as a monochrome multifunction peripheral, a copier, or a facsimile machine.

Further, the configurations and processings described in the embodiments with reference to FIG. 1 to FIG. 13 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image reading apparatus comprising:
an image reading device that reads a document, and generates image data;
an operation device to which an instruction of a user is inputted; and
a controller including a processor, and configured to execute, when the processor executes a control program, a process including:
setting, when a selection instruction for selecting one of a plurality of folders, use of which is restricted, as saving destination, is received through the operation device, and a predetermined condition for cancelling use restriction of the folder as the saving destination is satisfied, the folder indicated by the selection instruction as the saving destination of the image data; and
saving the image data in the set saving destination.

2. The image reading apparatus according to claim 1, further comprising:
a storage device containing a password of each of the folders; and
a display device,
wherein the controller is configured to:
cause the display device to display a password input screen, upon receipt of the selection instruction via the operation device;
acquire the password corresponding to the folder indicated by the selection instruction, from the storage device, when a character string is inputted via the operation device, and set the folder indicated by the selection instruction as the saving destination of the image data, when the acquired password accords with the character string; and
keep from setting the folder indicated by the selection instruction as the saving destination of the image data, when the acquired password discords from the character string.

3. The image reading apparatus according to claim 2, further comprising a storage device containing folder information and user information in association with each other,
wherein the controller is configured to:
(i) cause the display device to display a password input screen, when the information inputted via the operation device and the user information accord with each other, and the folder indicated by the folder information corresponding to the user information and the folder indicated by the selection instruction discord from each other;
set the folder indicated by the selection instruction as the saving destination of the image file, without causing the display device to display the password input screen, when the folder indicated by the folder information and the folder indicated by the selection instruction accord with each other; and
(ii) keep from setting the saving destination of the image file, when the information inputted via the operation device and the user information discord from each other.

4. The image reading apparatus according to claim 1, further comprising a storage device containing folder information and user information in association with each other,
wherein the controller is configured to:
enable, when the information inputted via the operation device and the user information accord with each other, the folder indicated by the folder information corresponding to the user information to be selected as the saving destination of the image file, among the plurality of folders, and disable other folders from being selected as the saving destination of the image file; and
keep from setting the saving destination of the image file, when the information inputted via the operation device and the user information discord from each other.

5. The image reading apparatus according to claim 4, further comprising a display device,
wherein, when the information inputted via the operation device and the user information accord with each other, the controller causes the display device to display a list including the folder indicated by the folder information corresponding to the user information, among the plurality of folders.
